(19) United States
(12) Patent Application Publication
(10) Pub. No.: US 2026/0188805 A1
(43) Pub. Date: Jul. 2, 2026

(54) SECONDARY BATTERY AND ELECTRONIC DEVICE INCLUDING THE SECONDARY BATTERY

(71) Applicant: SAMSUNG SDI CO., LTD., Yongin-si (KR)

(72) Inventor: Kiyoun JEON, Yongin-si (KR)

(21) Appl. No.: 19/344,819

(22) Filed: Sep. 30, 2025

(30) Foreign Application Priority Data
Dec. 31, 2024 (KR) 10-2024-0202920

(51) Int. Cl. H01M 50/169; H01M 10/0587; H01M 50/105; H01M 50/119; H01M 50/148; H01M 50/159

(52) U.S. Cl. CPC H01M 50/169; H01M 10/0587; H01M 50/119; H01M 50/148; H01M 50/159; H01M 50/105

(57) ABSTRACT

A secondary battery includes a body including a receiving portion in which a receiving space is formed and a flange portion that surrounds an open side of the receiving portion. An electrode assembly is accommodated in the receiving space, with the electrode assembly including a first electrode, a second electrode, and a separator disposed between the first electrode and the second electrode. A cover is coupled to the flange portion to seal the receiving portion, and a fixing portion is formed integrally with the cover on at least one side of the cover.

### CROSS-REFERENCE TO RELATED APPLICATION

The present application claims priority to and the benefit of Korean Application No. 10-2024-0202920, filed on Dec. 31, 2024, in the Korean Intellectual Property Office, the entire disclosure of which is incorporated by reference herein.

### BACKGROUND

### Technical Field

The present disclosure relates to a secondary battery and an electronic device including the secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In order to detachably couple such a secondary battery to an electronic device, an additional fixing component such as a screw tab must be coupled to the secondary battery. However, when a screw tab is used, additional components and processes are required, which increases manufacturing cost and production time. Furthermore, there is a concern that deformation may occur in the secondary battery during the process of coupling the secondary battery.

The above information disclosed in this Background section is for enhancement of understanding of the background of the present disclosure, and therefore, it may contain information that does not constitute related (or prior) art.

### SUMMARY

Embodiments of the present disclosure provide a secondary battery and an electronic device including the secondary battery that are capable of solving the above-described problems.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

According to embodiments of the present disclosure, a secondary battery may include a body comprising a receiving portion in which a receiving space is formed and a flange portion that surrounds an open side of the receiving portion, an electrode assembly accommodated in the receiving space, the electrode assembly including a first electrode, a second electrode, and a separator disposed between the first electrode and the second electrode,, a cover coupled to the flange portion to seal the receiving portion, and a fixing portion formed integrally with the cover on at least one side of the cover.

According to embodiments of the present disclosure, the fixing portion include a first fixing portion, and the secondary battery may further include a second fixing portion formed integrally with the flange portion on at least one side of the flange portion, with the second fixing portion corresponding to the first fixing portion.

According to embodiments of the present disclosure, the first fixing portion and the second fixing portion may be coupled by welding.

According to embodiments of the present disclosure, a region in which the first fixing portion and the second fixing portion are coupled by welding may be continuously connected to a region in which the body and the cover are coupled by welding.

According to some embodiments of the present disclosure, the fixing portion may extend outward from the cover.

According to embodiments of the present disclosure, the fixing portion may further include at least one end portion protruding outward from the cover.

According to embodiments of the present disclosure, the end portion may have a curved shape or a polygonal shape.

According to embodiments of the present disclosure, at least one through hole extends through the fixing portion.

According to embodiments of the present disclosure, the body and the cover may be formed of the same metallic material.

According to embodiments of the present disclosure, the metallic material may include stainless steel.

According to embodiments of the present disclosure, a secondary battery may include a body comprising a receiving portion in which a receiving space to accommodate is formed and a flange portion that surrounds an open side of the receiving portion, an electrode assembly accommodated in the receiving space, with the electrode assembly including a first electrode, a second electrode, and a separator disposed between the first electrode and the second electrode, a cover coupled to the flange portion to seal the receiving portion, and a fixing portion formed integrally with the flange portion on at least one side of the flange portion.

According to embodiments of the present disclosure, the fixing portion may extend outward from the flange portion.

According to embodiments of the present disclosure, the fixing portion may further include at least one end portion protruding direction from the flange portion.

According to embodiments of the present disclosure, an electronic device may include a secondary battery and a housing to which the secondary battery is coupled. The secondary battery may include a body including a receiving portion in which a receiving space to accommodate the electrode assembly is formed and a flange portion that surrounds one open side surface of the receiving portion, an electrode assembly accommodated in the body, with the electrode assembly including a first electrode, a second electrode, and a separator disposed between the first electrode and the second electrode, a cover coupled to the flange portion to seal the receiving portion, and a fixing portion formed integrally with the cover on at least one side of the cover.

According to some embodiments of the present disclosure, because a fixing portion to which a fixing member such as a screw can be fastened is made when the secondary battery is manufactured. Thus, additional processes may be minimized, and disassemblability and reusability of the secondary battery may be improved. Further, by manufacturing a customized fixing portion according to a structure and shape of the electronic device, space efficiency of the electronic device may be improved.

According to some embodiments of the present disclosure, it is unnecessary to couple a separate component for attachment to an electronic device to the secondary battery. Thus, deformation (strain) due to a structural difference between the component and the secondary battery is unlikely to occur, and thus structural stability of the secondary battery may be improved.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a secondary battery according to embodiments of the present disclosure.

FIG. 2 illustrates a fixing portion of a secondary battery according to an embodiment of the present disclosure.

FIG. 3 illustrates a fixing portion of a secondary battery according to an embodiment of the present disclosure.

FIG. 4 illustrates a fixing portion of a secondary battery according to an embodiment of the present disclosure.

FIG. 5 illustrates a fixing portion of a secondary battery according to an embodiment of the present disclosure.

FIG. 6 illustrates a fixing portion of a secondary battery according to an embodiment of the present disclosure.

FIG. 7 is a diagram of an electronic device including a secondary battery according to some embodiments of the present disclosure.

FIGS. 8A-8C illustrate a method of manufacturing a secondary battery according to an embodiment of the present disclosure.

FIGS. 9A-9C illustrate a method of manufacturing a secondary battery according to an embodiment of the present disclosure.

FIGS. 10A-10C illustrate a method of manufacturing a secondary battery according to an embodiment of the present disclosure.

FIG. 11 is a flowchart of a method of manufacturing an electronic device according to an embodiment of the present disclosure.

### DETAILED DESCRIPTION

Hereinafter, embodiments of the present disclosure will be described in detail with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked,” or “connected” to each other, or another component may be “interposed” between the components.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a) and 35 U.S.C. § 132(a).

Throughout the specification, when “A and/or B” is stated, it means A, B, or A and B, unless otherwise stated. That is, “and/or” includes any or all combinations of a plurality of items enumerated. When “C to D” is stated, it means C or greater and D or less, unless otherwise specified.

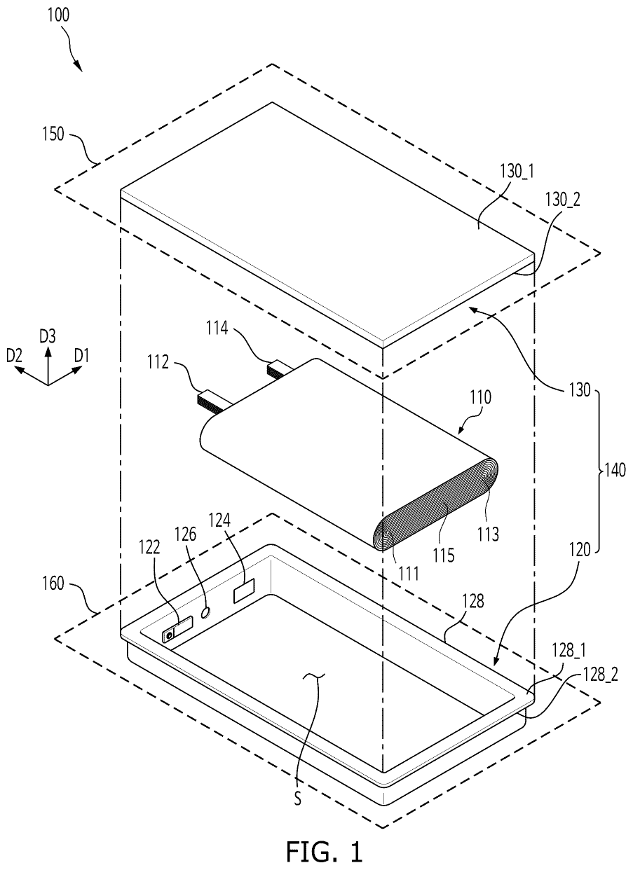

FIG. 1 illustrates a secondary battery 100 according to embodiments of the present disclosure.

Referring to FIG. 1, the secondary battery 100 may include an electrode assembly 110 including a first electrode 111, a second electrode 113, and a separator 115 disposed between the first electrode 111 and the second electrode 113. A body includes a receiving portion S in which a receiving space to accommodate the electrode assembly 110 is formed and a flange portion 128 that surrounds an open side of the receiving portion S. A cover 130 is coupled to the flange portion 128 to seal the receiving portion S. The secondary battery 100 may further include a first fixing portion 150 formed integrally with the cover 130 on at least one side of the cover 130 and/or a second fixing portion 160 formed integrally with the flange portion 128 on at least one side of the flange portion 128.

The electrode assembly 110 may be wound or stacked with an insulator. That is, the electrode assembly 110 may include a separator 115 interposed between the first electrode 111 corresponding to a positive electrode and the second electrode 113 corresponding to a negative electrode. The secondary battery 100 illustrated in FIG. 1 is a pouch-type secondary battery. But the secondary battery according to the present disclosure is not limited thereto and may be various other types of secondary batteries.

The positive electrode and the negative electrode may include a coated portion, which is a region in which an active material is applied to a current collector of a thin metal foil, and an uncoated portion where the active material is not provided. The positive electrode and the negative electrode are wound with the separator, which is an insulator, interposed between the electrodes. However, the present disclosure is not limited thereto. For example, the electrode assembly may have a structure in which a plurality of sheets of positive electrodes and negative electrodes are alternately stacked with the separator interposed between the electrodes.

The positive electrode active material layer may include a positive electrode active material and may further include a binder and/or a conductive material (e.g., an electrically conductive material).

The positive electrode active material may include a compound (lithiated intercalation compound) capable of intercalating and de-intercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, the following compounds represented by any one of the following Chemical Formulas may be used: LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high-nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and may be applied to a high-capacity, high-density rechargeable lithium battery.

For example, the positive electrode may further include an additive that may serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart electrical conductivity to the electrode. Any material that does not cause undesirable chemical change in a rechargeable lithium battery and conducts electrons may be used. Examples of the conductive material may include a carbon-based material such as natural graphite, artificial graphite, carbon black, acetylene black, ketjen black, a carbon fiber, a carbon nanofiber, and a carbon nanotube; a metal-based material containing copper, nickel, aluminum, or silver in the form of a metal powder or a metal fiber; a conductive polymer such as a polyphenylene derivative; or a mixture thereof.

Aluminum may be used as the current collector, but is not limited thereto.

The separator may include polyethylene, polypropylene, polyvinylidene fluoride, or a multilayer film of two or more layers thereof, and a mixed multilayer film such as a polyethylene/polypropylene two-layer separator, a polyethylene/polypropylene/polyethylene three-layer separator, a polypropylene/polyethylene/polypropylene three-layer separator, and the like.

The negative electrode for a lithium secondary battery may include a current collector and a negative electrode active material layer provided on the current collector. The negative electrode active material layer may include a negative electrode active material and may further include a binder and/or a conductive material (e.g., an electrically conductive material).

The negative electrode active material may include a material that reversibly intercalates and de-intercalates lithium ions, lithium metal, a lithium metal alloy, a material capable of doping and de-doping lithium, or a transition metal oxide.

The material that reversibly intercalates and de-intercalates lithium ions may include, for example, a carbon-based negative electrode active material such as crystalline carbon, amorphous carbon, or a combination thereof. The crystalline carbon may be graphite, such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping and de-doping lithium may be a Si-based negative electrode active material or a Sn-based negative electrode active material. The Si-based negative electrode active material may include silicon, a silicon-carbon composite, SiOx (0<x<2), or a Si-Q alloy (where Q is selected from an alkali metal, an alkaline-earth metal, a Group 13 element, a Group 14 element excluding Si, a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on surfaces of the silicon particles. For example, the silicon-carbon composite may include secondary particles (cores) in which primary silicon particles are assembled, and an amorphous carbon coating layer (shell) on surfaces of the secondary particles. The amorphous carbon may also be between the primary silicon particles; for example, the primary silicon particles may be coated with the amorphous carbon. The secondary particles may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene-propylene copolymer, polystyrene, polyurethane, polytetrafluoroethylene, polyvinylidene fluoride, polyethylene, polypropylene, polyamide-imide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene-propylene-diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart electrical conductivity to the electrode. Any material that does not cause undesirable chemical change in a rechargeable lithium battery and conducts electrons may be used. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, or silver in the form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may be a polymer film formed of any one polymer selected from polyolefins such as polyethylene and polypropylene; polyesters such as polyethylene terephthalate and polybutylene terephthalate; polyacetal; polyamide; polyimide; polycarbonate; polyether ketone; polyarylether ketone; polyether ketone; polyetherimide; polyamide-imide; polybenzimidazole; polyethersulfone; polyphenylene oxide; a cyclic olefin copolymer; polyphenylene sulfide; polyethylene naphthalate; a glass fiber; TEFLON; and polytetrafluoroethylene, or a copolymer or mixture of two or more of them.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and a combination thereof, but is not limited thereto.

The organic material and the inorganic material may be mixed in one coating layer, or a coating layer including an organic material and a coating layer including an inorganic material may be stacked.

A first electrode tab 112 and a second electrode tab 114 may be connected to uncoated portions of the first electrode 111 and the second electrode 113 by welding, and the first electrode 111 and the second electrode 113 may be punched to form uncoated portions. In the wound state, the first electrode tab 112 and the second electrode tab 114 may be arranged side by side at a predetermined interval. In other embodiments, the electrode assembly 110 may have any structure including electrode tabs.

The case 140 forms an external appearance of the secondary battery 100 and may be formed of a conductive metal such as aluminum, an aluminum alloy, or nickel-plated steel. The case 140 may include a metallic material such as stainless steel (SUS) or aluminum (Al). However, these are merely examples, and the case 140 may be formed of various metallic materials that provided the strength required for the secondary battery 100 and resistance to external impact.

The case 140 may include a body 120 including a receiving portion S having an end open in a direction perpendicular to an upper surface 128_1 of the flange portion 128 (the direction D3 as shown in FIG. 1) to accommodate the electrode assembly 110. The flange portion 128 extends from the open end in a direction outward from the body 120 (directions D1 or D2 as shown in FIG. 1). The receiving portion S of the body 120 may be configured to include an inner space to accommodate the electrode assembly 110 by press processing or the like.

A planar shape of the receiving portion S of the case 140 may be, for example, substantially rectangular. The case 140 may further include a cover 130 welded to the flange portion 128 to seal the open end of the receiving portion S. The cover 130 may be a flat plate disposed on an upper portion of the case 140 to seal the receiving portion S. The cover 130 may be sized large enough to cover the flange portion 128 and contact the flange portion 128. That is, a lower surface 130_2 of the cover 130 and the upper surface 128_1 of the flange portion 128 may contact each other. The body 120 and the cover 130 may be formed of the same metallic material, such as stainless steel.

By coupling the flange portion 128 and the cover 130, the body 120 and the cover 130 may form a single structure. The body 120 may be joined to the cover 130 by laser welding. However, the joining method in the present disclosure is not limited, and various joining methods capable of sealing the case 140 may be used. For example, as alternatives to laser welding, the cover 130 and the flange portion 128 may be joined by ultrasonic welding, brazing, laser brazing, welding, soldering, or the like.

A first electrode terminal 122 electrically connected to the first electrode tab 112 of the electrode assembly 110 and a second electrode terminal 124 electrically connected to the second electrode tab 114 of the electrode assembly 110 may be coupled to the body 120. The first electrode terminal 122 and the second electrode terminal 124 may be disposed on at least one side surface of the case 140, specifically on at least one side surface of the body 120. The positions of the first electrode terminal 122 and the second electrode terminal 124 are not limited to the position illustrated in FIG. 1, and various other positions are possible.

The case 140 may include an electrolyte injection port 126. For example, the electrolyte injection port 126 may be a through-hole formed in at least one side surface of the case 140. The through-hole may allow an electrolyte to be injected into the case 140 after the body 120 and the cover 130 are joined and sealed. The electrolyte injection port 126 may be sealed with a sealing member after the electrolyte is injected.

The first fixing portion 150 may be formed integrally with the cover 130. The first fixing portion 150 may extend in an outward from the cover 130. For example, the first fixing portion 150 may extend in a direction parallel to an upper surface 130_1 of the cover 130 (the direction D1 and/or D2 as shown in FIG. 1). At least a portion of the first fixing portion 150 may not overlap the flange portion 128 in a direction perpendicular to the upper surface 130_1 of the cover 130 (the direction D3 in FIG. 1). The first fixing portion 150 may fix or fasten the secondary battery 100 to an electronic device.

The second fixing portion 160 may be formed integrally with the flange portion 128. The second fixing portion 160 may extend outward from the flange portion 128. For example, the second fixing portion 160 may extend in a direction parallel to the upper surface 128_1 of the flange portion 128 (the direction D1 and/or D2 as shown in FIG. 1). At least a portion of the second fixing portion 160 may not overlap the cover 130 in a direction perpendicular to the upper surface 128_1 of the flange portion 128 (for example, in the direction D3). The second fixing portion 160 may fix or fasten the secondary battery 100 to an electronic device.

Depending on the embodiment, the secondary battery 100 may include only the first fixing portion 150 or only the second fixing portion 160. In still other embodiments, the secondary battery 100 may include both the first fixing portion 150 and the second fixing portion 160. Here, the first fixing portion 150 and the second fixing portion 160 may correspond to each other. That is, features such as a shape and structure of the first fixing portion 150 may be to the same as or similar to those of the second fixing portion 160. The first fixing portion 150 and the second fixing portion 160 may be welded together. A region in which the first fixing portion 150 and the second fixing portion 160 coupled by welding may be continuously connected to a region in which the body 120 and the cover 130 are coupled by welding.

The secondary battery 100 may be a lithium battery cell, a sodium battery cell, and the like. However, the scope of the present disclosure is not limited with respect to the type of battery, and the secondary battery 100 may be any type of battery that is capable of repeatedly supplying electricity by charging and discharging. When the secondary battery 100 is a lithium battery cell, the secondary battery 100 may be used in an electric vehicle (EV) due to its lifetime characteristics and high-rate characteristics are excellent. As another example, the secondary battery 100 may be used in a hybrid vehicle such as a plug-in hybrid electric vehicle (PHEV). In further embodiments, the lithium battery cell may be used in fields that require power storage in a wide range, for example, in a smart phone, a tablet PC, an electric bicycle, a power tool, and the like. But the present disclosure is not limited to these examples.

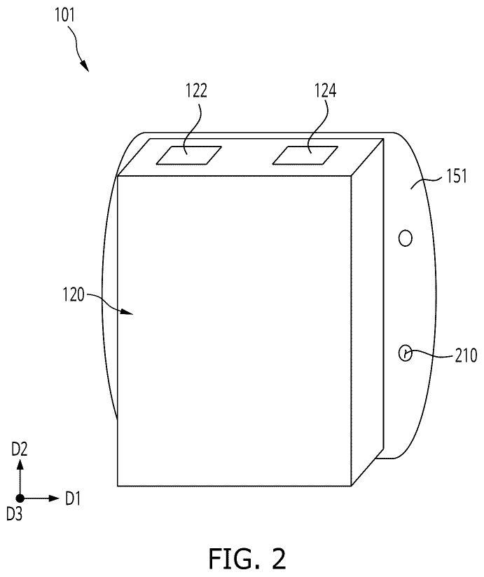

FIG. 2 illustrates a fixing portion 151 of a secondary battery 101 according to an embodiment of the present disclosure. The secondary battery 101 illustrated in FIG. 2 may include a configuration that is the same as or similar to the configuration of the secondary battery 100 illustrated in FIG. 1. In addition, the fixing portion 151 illustrated in FIG. 2 may have a configuration that is the same as or similar to the configuration of the first fixing portion 150 and/or the second fixing portion 160 of the secondary battery 100 illustrated in FIG. 1.

Referring to FIG. 2, the fixing portion 151 of the secondary battery 101 may be formed integrally with the cover of the secondary battery 101, for example, the cover 130 of the secondary battery 100 in FIG. 1. The fixing portion 151 of the secondary battery 101 may also be formed integrally with the flange portion of the secondary battery 101, for example, the flange portion 128 of the secondary battery 100 in FIG. 1. In other examples, the fixing portion 151 of the secondary battery 101 may be formed by welding a first fixing portion to the cover of the secondary battery 101 and a second fixing portion to the flange portion of the secondary battery 101. The following description, a case where the fixing portion 151 is formed integrally with the cover of the secondary battery 101 will be described. But the present disclosure is not limited thereto.

The fixing portion 151 of the secondary battery 101 may be formed by extending the cover of the secondary battery 101 in an outward direction from the case body 120. For example, the fixing portion 151 of the secondary battery 101 may be formed by extending in a first direction (the direction D1 shown in FIG. 2). At least a part of the fixing portion 151 may not overlap the body 120 in a direction different from the first direction. For example, a part of the fixing portion 151 does not overlap the body 120 in the direction D3 shown in FIG. 2. The fixing portion 151 may be formed on both sides of the cover 130 and have a curved shape.

The fixing portion 151 may include at least one through-hole 210 formed through the fixing portion 151. The through-hole 210 may be various shapes such as a circular shape or a polygonal shape. The through-hole 210 may be formed in a center of the fixing portion 151, but a position of the through-hole 210 is not limited thereto. A fastening structure such as a screw may be fastened to the fixing portion 151 by extending through the through-hole 210. Accordingly, the secondary battery 101 may be fixed to an electronic device.

As described above, by manufacturing the fixing portion 151 capable of fastening a fixing member such as a screw to the secondary battery 101 when the secondary battery 101 is made, additional processes may be minimized, and disassemblability and reusability of the secondary battery 101 may be improved. Further, since it is unnecessary to couple a separate component for attachment to an electronic device to the secondary battery 101, deformation (strain) due to a structural difference between the component and the secondary battery 101 is unlikely to occur. Thus, structural stability of the secondary battery 101 may be improved.

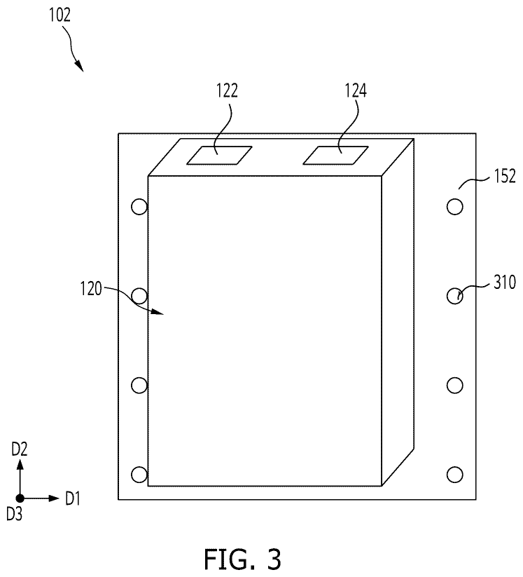

FIG. 3 illustrates a fixing portion 152 of a secondary battery 102 according to an embodiment of the present disclosure. The secondary battery 102 may include a configuration to the same as or similar to that of the secondary battery 100 illustrated in FIG. 1. The fixing portion 152 of the secondary battery 102 may have a configuration to the same as or similar to that of the first fixing portion 150 or the second fixing portion 160 illustrated in FIG. 1.

Referring to FIG. 3, the fixing portion 152 of the secondary battery 102 may be formed integrally with the cover of the secondary battery 102, such as in the cover 130 of the secondary battery 100 in FIG. 1. However, the fixing portion 152 may be formed integrally with the flange portion or may be formed by welding a first fixing portion to the cover and a second fixing portion formed integrally with the flange portion. The following description discloses a case where the fixing portion 152 is formed integrally with the cover of the secondary battery 102, but the disclosure is not limited thereto.

The fixing portion 152 of the secondary battery 102 may be formed by extending the cover of the secondary battery 102 such as the cover 130 of the secondary battery 100 in FIG. 1, in an outward direction. For example, the fixing portion 152 of the secondary battery 102 may be formed by extending in a first direction (the direction D1 shown in FIG. 3) and a second direction (the direction D2 shown in FIG. 3). However, the fixing portion 152 may not extend to a surface of the body 120 on which the first electrode terminal 122 and the second electrode terminal 124 are formed. At least a part of the fixing portion 152 may not overlap the body 120 in a direction different from the first direction. In FIG. 3, a part of the fixing portion 152 does not overlap the body 120 in the direction D3. The fixing portion 152 may have a rectangular shape. At least one through-hole 310 may be formed through the fixing portion 152. The through-hole 310 may be various shapes such as a circular shape or a polygonal shape. The through-hole 310 may be formed in a center of the fixing portion 152, but a position of the through-hole 310 is not limited thereto. A fastening structure such as a screw may be fastened to the fixing portion 152 by extending through the through-hole 310. Accordingly, the secondary battery 102 may be fixed to an electronic device.

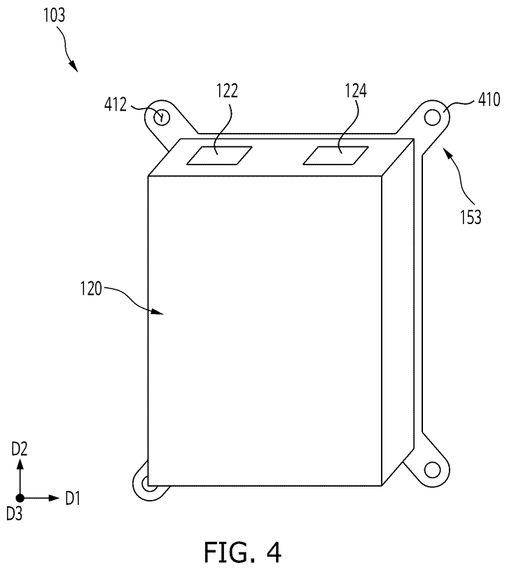

FIG. 4 illustrates a fixing portion 153 of a secondary battery 103 according to an embodiment of the present disclosure. The secondary battery 103 may include a configuration to the same as or similar to that of the secondary battery 100 illustrated in FIG. 1. The fixing portion 153 of the secondary battery 103 may have a configuration to the same as or similar to that of the first fixing portion 150 or the second fixing portion 160 illustrated in FIG. 1.

Referring to FIG. 4, the fixing portion 153 of the secondary battery 103 may be formed integrally with the cover of the secondary battery 103, which may be the cover 130 of the secondary battery 100 in FIG. 1. In embodiments, the fixing portion 153 may be formed integrally with the flange portion or may be formed by welding a first fixing portion to the cover and a second fixing portion formed integrally with the flange portion. The following describes a case where the fixing portion 153 is formed integrally with the cover of the secondary battery 103.

The fixing portion 153 of the secondary battery 103 may be formed by extending the cover of the secondary battery 103 (in an outward direction. The fixing portion 153 of the secondary battery 103 may be formed by extending in a first direction (the direction D1 shown in FIG. 4) and a second direction (, the direction D2 shown in FIG. 4). At least a portion of the fixing portion 153 may not overlap the body 120 in a direction (D3 in FIG. 4) different from the first direction. The fixing portion 153 may further include at least one end portion 410 protruding in an outward direction of the cover. As illustrated in FIG. 4, the number of end portions 410 may be four. At least one end portion 410 may be formed to protrude diagonally from a corner of the body 120 of the secondary battery 103. The end portion 410 may have a curved shape or a polygonal shape. But the present disclosure is not limited with respect to shape.

The fixing portion 153 may include at least one through-hole 412 formed through the fixing portion 153. The through-hole 412 may be various shapes such as a circular shape or a polygonal shape. The through-hole 412 may be formed in a center of the end portion 410, but a position of the through-hole 412 is not limited thereto.

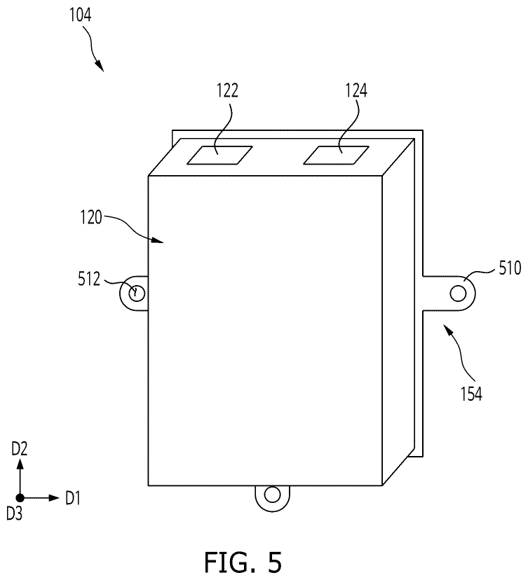

FIG. 5 illustrates a fixing portion 154 of a secondary battery 104 according to another embodiment of the present disclosure. The secondary battery 104 may include a configuration that is the same as or similar to that of the secondary battery 100 illustrated in FIG. 1. The fixing portion 154 of the secondary battery 104 may have a configuration that is the same as or similar to that of the first fixing portion 150 or the second fixing portion 160 illustrated in FIG. 1.

Referring to FIG. 5, the fixing portion 154 of the secondary battery 104 may be formed integrally with the cover of the secondary battery 104. However, the fixing portion 154 may be formed integrally with the flange portion or may be formed by welding a first fixing portion formed integrally with the cover and a second fixing portion formed integrally with the flange portion.

The fixing portion 154 of the secondary battery 104 may be formed by extending the cover of the secondary battery 104 in an outward direction from the case body 120. For example, the fixing portion 154 of the secondary battery 104 may be formed by extending in a first direction (the direction D1 shown in FIG. 5) and a second direction (the direction D2 shown in FIG. 5). At least a portion of the fixing portion 154 may not overlap the body 120 in a third direction (the direction D3 shown in FIG. 5). The fixing portion 154 may further include at least one end portion 510 protruding in an outward direction from the cover. In the example depicted in FIG. 5, there are three end portions 510. In embodiments, at least one end portion 510 may be formed to protrude from three sides of the body 120 of the secondary battery 104. But the end portion 510 may not be formed on a side surface on which the first electrode terminal 122 and the second electrode terminal 124 are formed. The end portion 510 may have a curved shape or a polygonal shape, but is not limited thereto and may have various other shapes.

The fixing portion 154 may include at least one through-hole 512 formed through the fixing portion 154. The through-hole 512 may be various shapes such as a circular shape or a polygonal shape. The through-hole 512 may be formed in a center of the end portion 510, but a position of the through-hole 512 is not limited thereto.

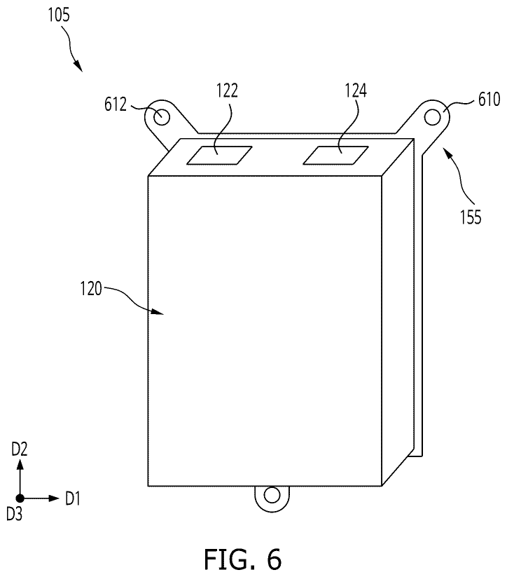

FIG. 6 illustrates a fixing portion 155 of a secondary battery 105 according to an embodiment of the present disclosure. The secondary battery 105 may include a configuration that is the same as or similar to that of the secondary battery 100 illustrated in FIG. 1. The fixing portion 155 of the secondary battery 105 may have a configuration that is the same as or similar to that of the first fixing portion 150 or the second fixing portion 160 illustrated in FIG. 1.

Referring to FIG. 6, the fixing portion 155 of the secondary battery 105 may be formed integrally with the cover of the secondary battery 105. However, the fixing portion 155 may be formed integrally with the flange portion or may be formed by welding a first fixing portion formed integrally with the cover and a second fixing portion formed integrally with the flange portion. The following description is directed to a case where the fixing portion 155 is formed integrally with the cover of the secondary battery 105.

The fixing portion 155 of the secondary battery 105 may extend the cover of the secondary battery 105 in an outward direction. For example, the fixing portion 155 of the secondary battery 105 may extend in a first direction (the direction D1 shown in FIG. 6) and a second direction (the direction D2 shown in FIG. 6). At least a portion of the fixing portion 155 may not overlap the body 120 in a third direction (the direction D3 shown in FIG. 6). The fixing portion 155 may further include at least one end portion 610 protruding in an outward direction of the cover. In the example depicted in FIG. 6, there are three end portions 610. Here, among the end portions 610, two end portions 610 are formed to protrude diagonally from two upper corners of the body 120 of the secondary battery 105, and the other end portion 610 may be formed to protrude from a lower side surface of the body 120. The end portion 610 may have a curved shape or a polygonal shape, but is not limited thereto and may be various other shapes.

The fixing portion 155 may include at least one through-hole 612 formed through the fixing portion 155. The through-hole 612 may be various shapes such as a circular shape or a polygonal shape. The through-hole 612 may be formed in a center of the end portion 610, but a position of the through-hole 612 is not limited thereto.

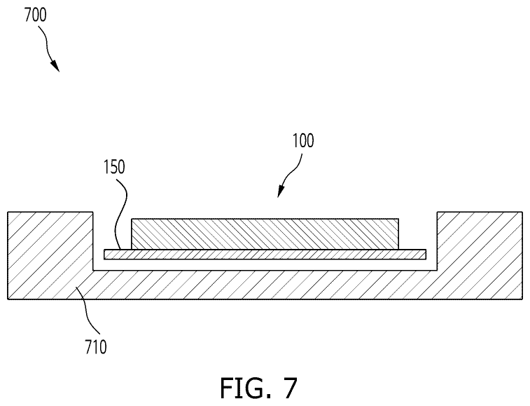

FIG. 7 is an illustration of an electronic device 700 including the secondary battery 100 according to some embodiments of the present disclosure.

Referring to FIG. 7, the electronic device 700 may include the secondary battery 100 and a housing 710 to which the secondary battery 100 is coupled. The secondary battery 100 may be detachably coupled to an electronic device 700 by the first fixing portion 150 and a fixing member extending through the first fixing portion 150. As described above, the first fixing portion 150 may be replaced/substituted with the second fixing portion 160. Further, the first fixing portion 150 may be replaced/substituted with a fixing portion obtained by welding the first fixing portion 150 and the second fixing portion 160. The fixing member may include, for example, a screw. The secondary battery 100 may be any of the secondary batteries 101, 102, 103, 104, and 105 described above with reference to FIGS. 2 to 6.

The electronic device 700 may use the secondary battery 100 as part or all of a power source. When the secondary battery 100 is used as part of the power source, an alternating-current power may be directly used, and only the secondary battery 100 is used in the electronic device 700. The electronic device 700 according to some embodiments of the present disclosure may be any device to which the secondary battery 100 can be mounted. For example, the electronic device 700 may be various small electronic devices such as a smart phone, a portable phone, a PDA, and a notebook computer, or an electric vehicle, a plug-in hybrid vehicle, an electric bicycle, a power tool, and the like. But the present disclosure is not limited to these examples.

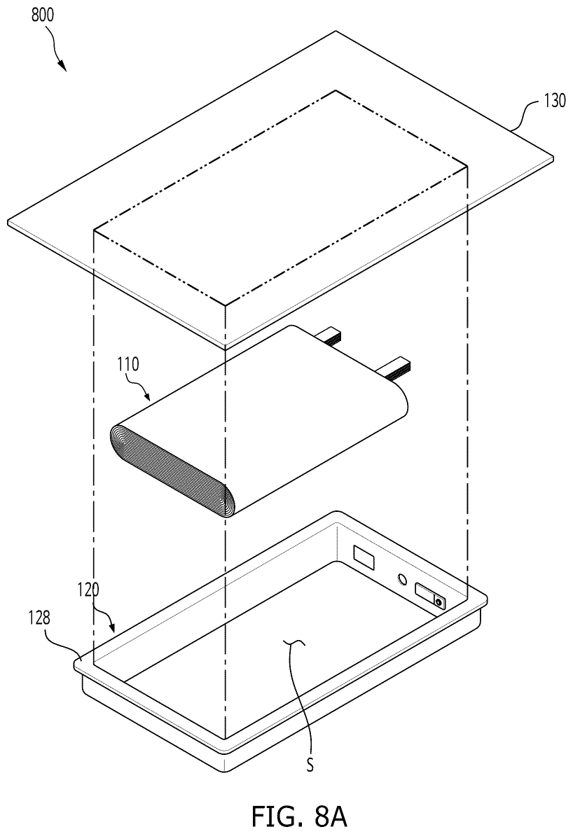

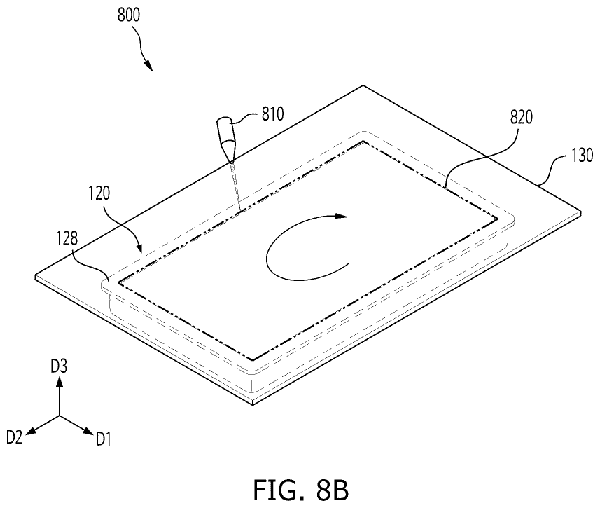

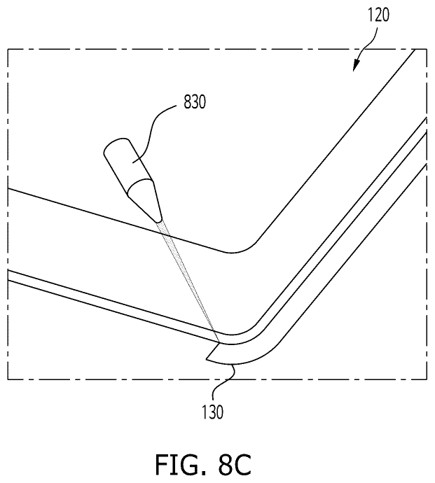

FIGS. 8A-8C illustrate a method of manufacturing a secondary battery 800 according to an embodiment of the present disclosure. The secondary battery 800 may include a configuration that is the same as or similar to the configuration of the secondary batteries 100, 101, 102, 103, 104, and 105 depicted in FIGS. 1 to 6.

Referring to FIG. 8A, a method of manufacturing the secondary battery 800 may include accommodating the electrode assembly 110 in the receiving portion S of the body 120. Then, the cover 130 may be coupled to the flange portion 128 of the body 120 to seal the receiving portion S. Here, an area of the cover 130 may be greater than an area of the body 120.

Referring to FIG. 8B, the method of manufacturing the secondary battery 800 may include welding the cover 130 and the flange portion 128 together. For example, a welder 810 may be used to weld the cover 130 to the flange portion 128. The cover 130 and the flange portion 128 may be joined by laser welding or the like. The welding may proceed in a clockwise direction along a welding line 820 indicated by a dotted line in FIG. 8B along a perimeter of the flange portion 128, but the present disclosure is not limited in this regard.

Referring to FIG. 8C, the method of manufacturing the secondary battery 800 may include cutting at least one side of the cover 130 to form a fixing portion, thereby manufacturing the secondary battery 800. Referring to FIGS. 1 to 6, the fixing portion may be the fixing portion disclosed in the above-described embodiments (for example, the first fixing portion 150). Although not illustrated in FIG. 8C, the secondary battery 800 may be made by cutting the flange portion together with the cover 130, except for a portion where the fixing portion is formed. The cover 130 and the flange portion may be cut by a cutter 830, which may be a laser cutter. The cover 130 may be cut into various shapes to form the fixing portion. For example, the cover 130 may be cut into the shapes of the fixing portions 151, 152, 153, 154, and 155 depicted in FIGS. 2 to 6.

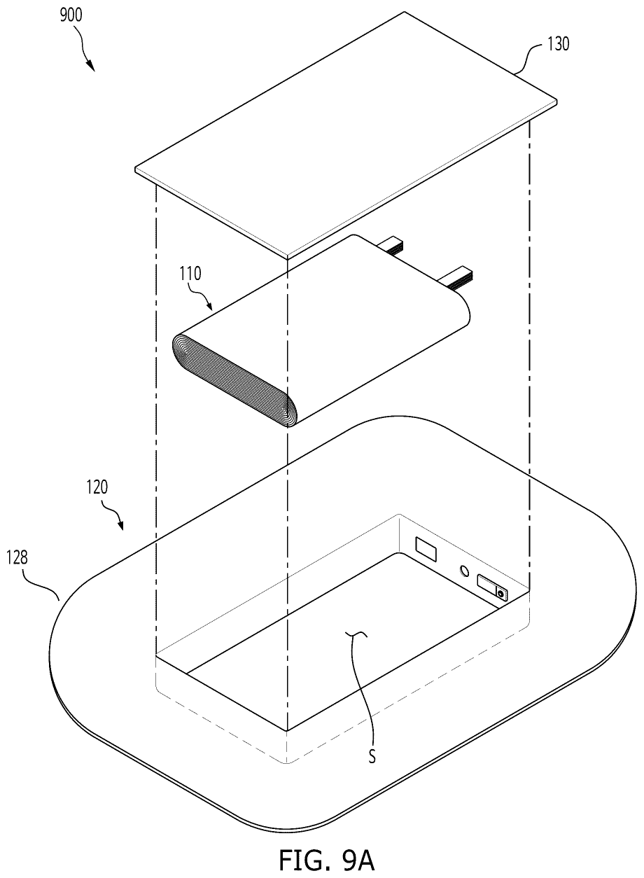

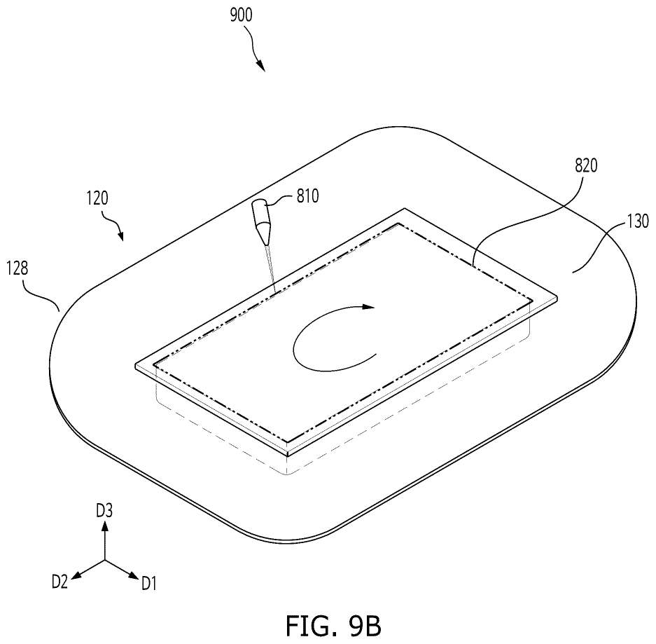

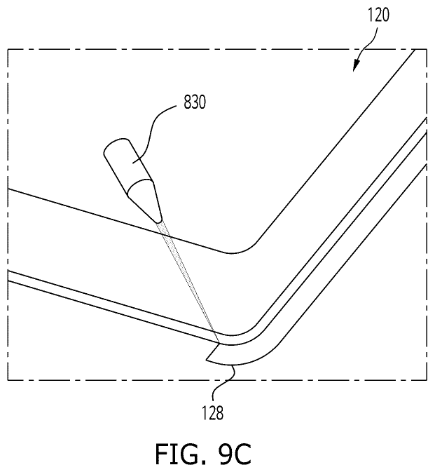

FIGS. 9A-9C illustrate a method of manufacturing a secondary battery 900 according to another embodiment of the present disclosure. Here, the secondary battery 900 may include a configuration that is the same as or similar to that of the secondary batteries 100, 101, 102, 103, 104, and 105 depicted in FIGS. 1 to 6.

Referring to FIG. 9A, a method of manufacturing the secondary battery 900 may include accommodating the electrode assembly 110 in the receiving portion S of the body 120. Then, the cover 130 may be coupled to the flange portion 128 of the body 120 to seal the receiving portion S. An area of the cover 130 may be smaller than an area of the body 120. Specifically, a residual area may remain on the flange portion 128 even after the cover 130 and the flange portion 128 are coupled together.

Referring to FIG. 9B, the method may include welding the cover 130 and the flange portion 128 together. For example, the cover 130 may be welded to the flange portion 128 by laser welding or the like. The welding may proceed in a clockwise direction along the welding line 820 indicated by a dotted line in FIG. 9B along a perimeter of the flange portion 128, but the present disclosure is not limited thereto.

Referring to FIG. 9C, the method of manufacturing the secondary battery 900 may include cutting at least one side of the flange portion 128 to form a fixing portion. Referring to FIGS. 1 to 6, the fixing portion may be formed integrally with the flange portion 128 such that the fixing portion corresponds to the above-described embodiments. Although not illustrated in FIG. 9C, the secondary battery 900 may be made by cutting the cover together with the flange portion 128, except for a portion where the fixing portion is formed. The flange portion 128 and the cover may be cut by the cutter 830, which may be a laser cutter. The flange portion 128 may be cut into various shapes to form the fixing portion. For example, the flange portion 128 may be cut into the shapes of the fixing portions 151, 152, 153, 154, and 155 depicted in FIGS. 2 to 6.

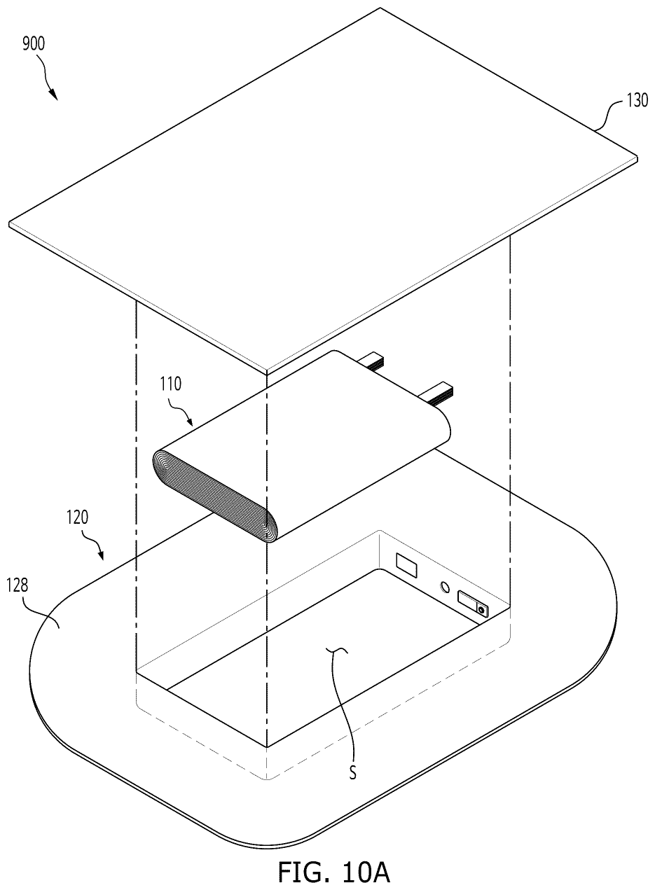

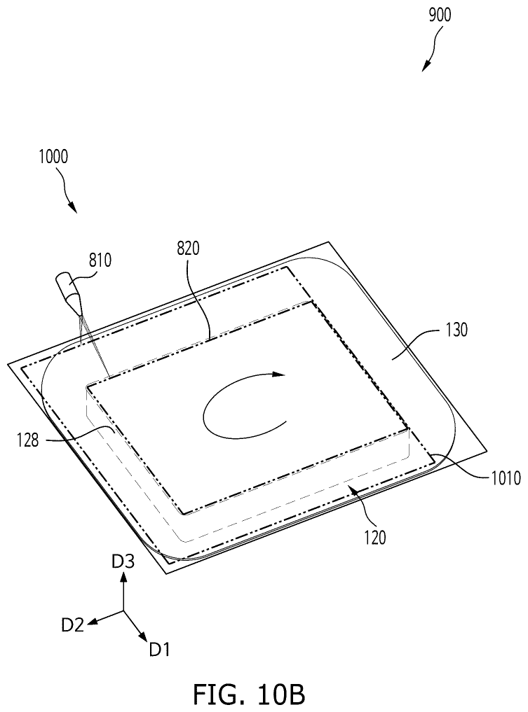

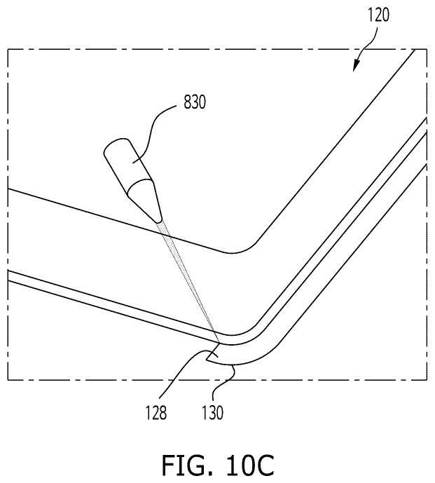

FIGS. 10A-10C illustrate a method of manufacturing a secondary battery 1000 according to an embodiment of the present disclosure. Here, the secondary battery 1000 may include a configuration that is the same as or similar to that of the secondary batteries 100, 101, 102, 103, 104, and 105 depicted in FIGS. 1 to 6.

Referring to FIG. 10A, a method of manufacturing the secondary battery 1000 may include accommodating the electrode assembly 110 in the receiving portion S of the body 120. Then, c the cover 130 may be coupled to the flange portion 128 of the body 120 to seal the receiving portion S.

Referring to FIG. 10B, the method of manufacturing the secondary battery 900 may include welding the cover 130 and the flange portion 128 together. For example, the cover 130 may be welded to the flange portion 128 through the using the laser welder 810 or the like. The welding may proceed in a clockwise direction along a first welding line 820 indicated by a dotted line in FIG. 10B along a perimeter of the flange portion 128, but the present disclosure is not limited thereto. Further, to make the fixing portion, in addition to the first welding line 820, welding may be performed along a second welding line 1010 to join the cover 130 and the flange portion 128 together. For example, referring to FIG. 1, the cover 130 and the flange portion 128 may be joined by welding along the second welding line 1010 to weld the first fixing portion 150 formed integrally with the cover 130 and the second fixing portion 160 formed integrally with the flange portion 128. The second welding line 1010 may be a welding line for forming the fixing portion 152 depicted in FIG. 3. However, the second welding line 1010 may have any shape for making various shapes of the fixing portion depicted in FIGS. 1 to 6.

Referring to FIG. 10C, the method of manufacturing the secondary battery 1000 may include cutting at least one side of the cover 130 and the flange portion 128 to form a fixing portion, thereby manufacturing the secondary battery 1000. Referring to FIGS. 1 to 6, the fixing portion formed integrally with the cover 130 may be the fixing portion as disclosed in the above-described embodiments. In addition, the fixing portion formed integrally with the flange portion 128 may be the fixing portion disclosed in the above-described embodiments. The secondary battery 1000 may be made by cutting the cover 130 and the flange portion 128 except for a portion where the fixing portion is formed. The cover 130 and the flange portion 128 may be cut by the cutter 830. The cutter 830 may be, for example, a laser cutter. The cover 130 and the flange portion 128 may be cut into various shapes to form the fixing portion. For example, the cover 130 and the flange portion 128 may be cut into a shape of the fixing portions 151, 152, 153, 154, and 155 depicted in FIGS. 2 to 6.

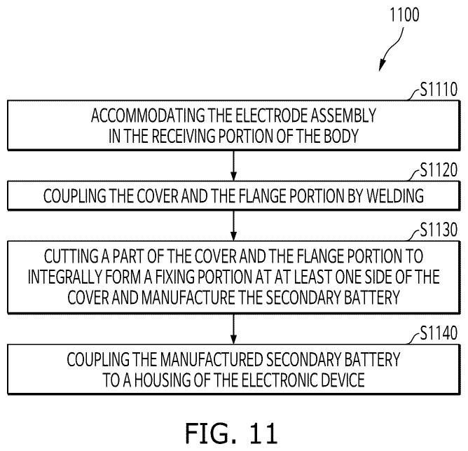

FIG. 11 is a flowchart 1100 of a method of manufacturing an electronic device according to an embodiment of the present disclosure.

Referring to FIG. 11, the flowchart 1100 may start by performing a step S1110 of accommodating the electrode assembly in the receiving portion of the body. For example, referring to FIG. 1, the electrode assembly 110 may be wound or stacked with the separator 115, which is an insulator, interposed between the first electrode 111 corresponding to a positive electrode and the second electrode 113 corresponding to a negative electrode. The body 120 may comprise the case 140 and may include the receiving portion S having an open end in a first direction (the direction D3 depicted in FIG. 1) to accommodate the electrode assembly 110 and the flange portion 128 extending in a direction different from the first direction D3 (for example, in the direction D1 or D2 depicted in FIG. 1) from the open end. The cover 130 may be configured as a flat plate disposed on an upper portion of the case 140 to seal the receiving portion S. The cover 130 may be sized large enough to cover the flange portion 128 and to contact the flange portion 128. That is, the lower surface 130_2 of the cover 130 and the upper surface 128_1 of the flange portion 128 may be in surface contact with each other. By coupling the flange portion 128 and the cover 130, the body 120 and the cover 130 may form a single structure.

Next, a step S1120 of coupling the cover and the flange portion together by welding may be performed. For example, referring to FIG. 1, the cover 130 and the flange portion 128 may be welded together by laser welding or the like.

Next, a step S1130 of cutting a part of the cover and the flange portion to integrally form a fixing portion on at least one side of the cover and manufacture the secondary battery may be performed. Referring to FIG. 1, the first fixing portion 150 may be formed integrally with the cover 130, and the second fixing portion 160 may be formed integrally with the flange portion 128. Further, the fixing portion may be formed by coupling the first fixing portion 150 and the second fixing portion 160 described above. Referring to FIGS. 2 to 6, the fixing portion may have various shapes and may include at least one through-hole.

Finally, a step S1140 of coupling the manufactured secondary battery to a housing of the electronic device may be performed. For example, referring to FIG. 7, the secondary battery 100 may be coupled to the housing 710 of the electronic device 700. As described above, the fixing portion capable of fastening a fixing member such as a screw to the secondary battery may be made in advance. Accordingly, additional processes may be minimized, and disassemblability and reusability of the secondary battery may be improved. Further, by making a customized fixing portion according to a structure and shape of the electronic device, space efficiency of the electronic device may be improved. Still further, since it is unnecessary to couple a separate component for attachment to an electronic device to the secondary battery, deformation (strain) due to a structural differences between the component and the secondary battery is unlikely to occur, and thus structural stability of the secondary battery may be improved.

Although the present disclosure has been described with reference to embodiments and drawings illustrating aspects thereof, the present disclosure is not limited thereto. Various modifications and variations can be made by a person skilled in the art to which the present disclosure belongs within a scope of the technical spirit of the present disclosure.

### DESCRIPTION OF SOME REFERENCE SYMBOLS

100: secondary battery
110: electrode assembly
111: first electrode
112: first electrode tab
113: second electrode
114: second electrode tab
115: separator
120: body
122: first electrode terminal
124: second electrode terminal
126: electrolyte injection port
128: flange portion

What is claimed is:

1. A secondary battery comprising:
a body comprising a receiving portion in which a receiving space is formed and a flange portion that surrounds an open side of the receiving portion;
an electrode assembly accommodated in the receiving space, the electrode assembly comprising a first electrode, a second electrode, and a separator disposed between the first electrode and the second electrode;
a cover coupled to the flange portion to seal the receiving portion; and
a fixing portion formed integrally with the cover on at least one side of the cover.

2. The secondary battery as claimed in claim 1, wherein the fixing portion includes a first fixing portion, and the secondary battery further comprises a second fixing portion formed integrally with the flange portion on at least one side of the flange portion, with the second fixing portion corresponding to the first fixing portion.

3. The secondary battery as claimed in claim 2, wherein the first fixing portion and the second fixing portion are coupled by welding.

4. The secondary battery as claimed in claim 3, wherein a region in which the first fixing portion and the second fixing portion are coupled by welding is continuously connected to a region in which the body and the cover are coupled by welding.

5. The secondary battery as claimed in claim 1, wherein the fixing portion extends outward from the cover.

6. The secondary battery as claimed in claim 5, wherein the fixing portion further comprises at least one end portion protruding outward from the cover.

7. The secondary battery as claimed in claim 6, wherein the end portion has a curved shape or a polygonal shape.

8. The secondary battery as claimed in claim 1, wherein at least one hole extends through the fixing portion.

9. The secondary battery as claimed in claim 1, wherein the body and the cover are formed of a same metallic material.

10. The secondary battery as claimed in claim 9, wherein the metallic material comprises stainless steel.

11. A secondary battery comprising:
a body comprising a receiving portion in which a receiving space to accommodate is formed and a flange portion that surrounds an open side of the receiving portion;
an electrode assembly accommodated in the receiving space, the electrode assembly comprising a first electrode, a second electrode, and a separator disposed between the first electrode and the second electrode;
a cover coupled to the flange portion to seal the receiving portion; and
a fixing portion formed integrally with the flange portion on at least one side of the flange portion.

12. The secondary battery as claimed in claim 11, wherein the fixing portion extends outward from the flange portion.

13. The secondary battery as claimed in claim 12, wherein the fixing portion further comprises at least one end portion protruding outward from the flange portion.

14. The secondary battery as claimed in claim 13, wherein the end portion has a curved shape or a polygonal shape.

15. The secondary battery as claimed in claim 11, wherein at least one hole extends through the fixing portion

16. The secondary battery as claimed in claim 11, wherein the body and the cover are formed of a same metallic material.

17. The secondary battery as claimed in claim 16, wherein the metallic material comprises stainless steel.

18. An electronic device, comprising:
a secondary battery; and
a housing to which the secondary battery is coupled,
wherein the secondary battery comprises:
a body comprising a receiving portion in which a receiving space is formed and a flange portion that surrounds an open side of the receiving portion;
an electrode assembly accommodated in the receiving space, the electrode assembly comprising a first electrode, a second electrode, and a separator disposed between the first electrode and the second electrode;
a cover coupled to the flange portion to seal the receiving portion; and
a fixing portion formed integrally with the cover on at least one side of the cover.

19. The electronic device as claimed in claim 18, wherein the fixing portion extends outward from the cover.

20. The electronic device as claimed in claim 18, wherein at least one through hole extends through the fixing portion.
